(19) United States
(12) Patent Application Publication
(10) Pub. No.: US 2014/0005053 A1
(43) Pub. Date: Jan. 2, 2014

(54) CURRENT-RISE LIMITATION IN HIGH-VOLTAGE DC SYSTEMS

(71) Applicant: ABB Technology AG, Zurich (CH)

(72) Inventors: Christian Schacherer, Niederrohrdorf (CH); Markus Abplanalp, Baden Dattwil (CH); Markus Bujotzek, Zurich (CH); Emmanouil Panousis, Baden (CH)

(73) Assignee: ABB Technology AG, Zurich (CH)

(21) Appl. No.: 14/017,876

(22) Filed: Sep. 4, 2013

Related U.S. Application Data
(63) Continuation of application No. PCT/EP2012/053525, filed on Mar. 1, 2012.

(30) Foreign Application Priority Data
Mar. 4, 2011 (EP) 11001813.2

(51) Int. Cl. H02H 9/02

(52) U.S. Cl. CPC H02H 9/023
USPC 505/211; 361/93.9

(57) ABSTRACT

To limit current rise in a high voltage DC system, the current can be led through a current rise limiter. An exemplary current rise limiter can have an inductance that increases with the current I through the current rise limiter and/or with a time-derivative dI/dt of the current I. In such a system, the current rise limiter can have minor influence on normal operation, but can limit the rise rate of the current in the event of a fault to, for example, provide more time to switch off the current.

### RELATED APPLICATION(S)

This application claims priority as a continuation application under 35 U.S.C. §120 to PCT/EP2012/053525, which was filed as an International Application on Mar. 1, 2012 designating the U.S., and which claims priority to European Application 11001813.2 filed in Europe on Mar. 4, 2011. The entire contents of these applications are hereby incorporated by reference in their entireties.

### FIELD

The present disclosure relates to a method for limiting current rise in a high voltage DC network under fault conditions. It also relates to a high-voltage DC circuit breaker having a switching assembly for interrupting a high-voltage DC current and an inductive current rise limiter arranged in series to the switching assembly.

### BACKGROUND INFORMATION

In high-voltage direct current (HVDC) systems (DC grids), known mechanical circuit breakers have to be able to switch off large currents very quickly because there are no natural current zero crossings, thus making it difficult to extinguish an arc in the circuit breaker. For example, in case of a ground fault, the current can rise quickly, and therefore a circuit breaker has to be fast, which makes it difficult to use mechanical circuit breakers at all.

To alleviate these issues, it has been known to align an inductive current rise limiting element in series to the switching assembly of the circuit breaker. Such a current rise limiting element may, for example, be an air coil with a constant inductance of about 100 mH. The inductance inherently limits the rise rate of the current in the event of a fault, thereby giving the switching assembly more time for switching off the current.

It can be advantageous to use current rise limiters of even higher inductance, but this can lead to system instabilities and can, for example, impair the system's ability to support fast (but regular) load changes. Also, inductive current limiters of large inductance can be bulky and expensive.

### SUMMARY

A method is disclosed for limiting a current rise in a high voltage DC network, the method comprising: selecting a current rise limiter which has an inductance that increases with a time-derivative dI/dt of a current I; and arranging the inductive current rise limiter in the network.

A high-voltage DC circuit breaker is also disclosed, comprising: a switching assembly for interrupting a high-voltage DC current I; and an inductive current rise limiter arranged in series to said switching assembly, wherein said current rise limiter has an inductance that will increase with a time-derivative dI/dt of said current I.

### BRIEF DESCRIPTION OF THE DRAWINGS

Exemplary embodiments and features thereof will become apparent from the following detailed description. The detailed description makes reference to the annexed drawings, wherein:

FIG. 1 is a circuit diagram of an exemplary circuit breaker with a current rise limiter;

FIG. 2 is an exemplary current vs. time diagram of the circuit breaker;

FIG. 3 is an exemplary embodiment of a current rise limiter;

FIG. 4 is another exemplary embodiment of a current rise limiter;

FIG. 5 is another exemplary embodiment of a current rise limiter; and

FIG. 6 is another exemplary embodiment of a current rise limiter.

### DETAILED DESCRIPTION

Exemplary methods and circuit breakers that can limit the current rise in a high voltage DC network effectively are disclosed herein.

For example, methods, circuit breakers, their use and high-voltage DC networks including such circuit breakers are disclosed.

The current rise can be limited by arranging an inductive current rise limiter in the network. The current rise limiter can have an inductance that increases with the current I that flows through the current rise limiter, and/or with the time-derivative dI/dt of the current I.

Hence, in an exemplary normal mode of operation, where the current I or its time derivative dI/dt is within a nominal range, the inductance of the current rise limiter is comparatively small and therefore has a comparatively weak influence on stability of the network. However, in the event of a fault, the current I and its time-derivative dI/dt increase, which leads to an increase of the inductance of the limiter and therefore can improve the limiter's ability to limit the rise of the current.

Exemplary methods as disclosed herein can be particularly useful in, for example, a high-voltage DC circuit breaker. Such a circuit breaker, which can be used to break a high-voltage DC current, can include a switching assembly for interrupting the high-voltage DC current as well as the inductive current rise limiter arranged in series to the switching assembly.

The use of limiters whose inductance rises with the current I or its time derivative dI/dt has been known for AC networks. However, in AC systems, these limiters have been used as current limiters, not as current rise limiters. When the AC current increases, their inductance increases, which in turn leads to a limitation of the AC current.

In a DC system, this AC based mechanism would not work and therefore these limiters could not be used as current limiters. As such, those skilled in the art would not have been motivated to use such limiters in a DC system. However, the present inventors have recognized that such limiters can be used as current rise limiters in a DC system.

Advantageously, the current rise limiter has an inductance that increases with the current I. Such a limiter generates an additional limiting effect on the rise rate of the current only when the current has reached a level above nominal, while its influence on current fluctuations at nominal current is low, thereby maintaining the system's capability to support sudden load changes.

Definition(s):

For purposes of describing exemplary embodiments in greater detail, the following exemplary definitions will be adopted.

The term “high voltage” encompasses voltages of 36 kV or more.

A current rise limiter having an “inductance that increases with a current” or “with a time-derivative dI/dt of said current” designates any device whose inductance increases automatically with the current or its time-derivative. In such a device, there may, for example, be a functional, bijective relationship between inductance and current (or time-derivative), or the relationship may not be bijective, but for example exhibit hysteresis effects. The change of inductance may for example also be triggered actively once the current or current rise exceeds a certain threshold. Also, the decrease of the inductance, when the current or its time-derivative drops back, may not be instantaneous, but rather may only occur after a certain delay, such as in embodiments where a superconductor has to regain its superconductivity.

Overview:

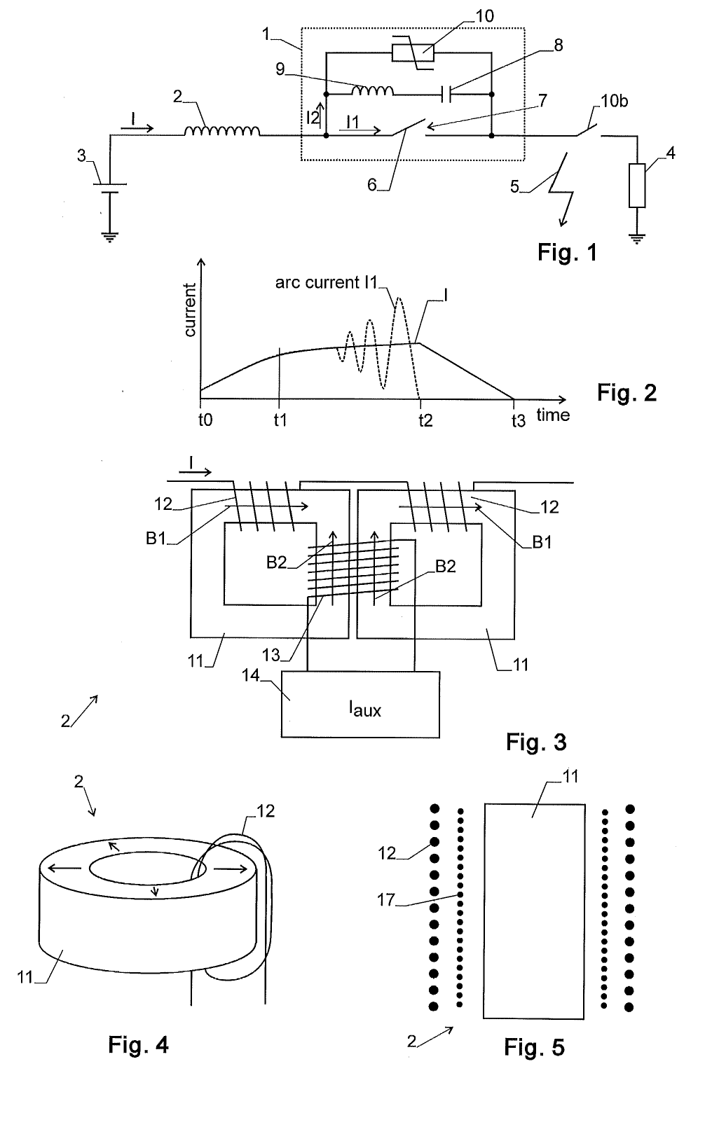

FIG. 1 shows an exemplary circuit breaker having a switching assembly 1 and an inductive current rise limiter 2 arranged in series thereto. A current I is flowing through switching assembly 1 and current rise limiter 2. The circuit breaker is arranged in a high voltage DC network, which is schematically represented by a DC voltage source 3 and a load 4.

Those skilled in the art will appreciate that the network can be much more complex than that, with at least three voltage sources and/or loads on both sides of the circuit breaker. In addition, the current I may change direction when the distribution of loads and sources in the network changes dynamically.

A purpose of switching assembly 1 is to switch off the current I, for example in the event of a ground fault as indicated by 5. In the embodiment of FIG. 1, switching assembly 1 uses a passive resonance mechanism for switching of the current, and it includes at least one mechanical switch 6 with an arc gap 7. Switch 6 may for example be a blast circuit breaker, such as a puffer circuit breaker.

Arc gap 7 is arranged in a resonant circuit having a capacitor 8 and an inductance 9 (inductance 9 may for example be formed by a discrete inductor, or by the self inductance of the leads of the cables and the switch). In addition, an arrester (varistor) 10 is arranged parallel to switch 6.

As already mentioned, current rise limiter 2 can have an inductance that rises with the current I; for example, with the absolute value of the current I, or with the time-derivative dI/dt, such as with the absolute value of the time-derivative dI/dt.

An exemplary operation of the circuit breaker of FIG. 1 is schematically illustrated in FIG. 2, which shows a time behaviour of the current I and the current in the arc in the event of a fault. It is assumed that the current rise limiter has an inductance that increases with the current I.

In FIG. 2, a ground fault occurs at a time t0 and (ideally) switch 6 is opened at the same time, thereby forming an arc in arc gap 7.

As can be seen, the current I begins to rise quickly. However, this leads to an increase of the inductance of current rise limiter 2, which in turn increasingly limits the rise rate of current I. In the example of FIG. 2, this becomes apparent approximately at a time t1.

Also, and as can be seen in FIG. 2, oscillations begin to build up in the resonant circuit 7, 8, 9 and lead to current fluctuations in arc gap 7. The build-up of these oscillations can be due to the negative dU/dI-characteristics of arc gap 7.

At a time t2, the oscillations reach an amplitude where they are sufficient to compensate the current I and therefore to generate a current zero crossing in the lower branch, for example, in the arc, at which time the arc is extinguished and the current I₁ in the lower branch is cut off. Another exemplary possibility is to use an inverse current injection in order to actively create a zero current in the lower branch. Current I will continue to flow through the upper branch and can be interrupted by a switch 10b at time t3. Hence, the current zero crossing generated by one of these features allows for use of known AC breaker technology, such as the switch 6 or mechanical switch 6 or circuit breaker 6 or puffer circuit breaker 6 or even self-blast circuit breaker 6.

Due to the rise limitation induced by current rise limiter 2, more time remains for the creation of a current zero condition before the current reaches a level where it can not be compensated by these oscillations or the injected current.

Current Rise Limiter:

In the following, some exemplary advantageous embodiments of current rise limiter 2 are discussed.

In the exemplary embodiment of FIG. 3, current rise limiter 2 includes two annular iron cores 11.

A first coil 12 is wound around each core 11, with the two coils 12 being arranged in series and carrying the current I; for example, the first coils 12 are in series to switching assembly 1.

In addition, a second coil 13 is wound around both cores 11. An auxiliary DC current Iₐᵤₓ is generated by a current source 14 and fed through second coil 13.

The winding sense of the various coils can be chosen such that one of the coils 12 increases its inductance for large positive currents I while the other one increases its inductance for large negative currents I. This is discussed in more detail for the left hand core 11 of FIG. 3.

The auxiliary current Iₐᵤₓ in the second coil 13 generates a magnetic field Hₐᵤₓ which drives the iron core 11 into saturation above the saturation flux density Bₛₐₜ. The permeability of the iron core 11 and thus the inductance of the current rise limiter 2 is low. The current I in the first coil 12 generates in at least one core 11 an additional magnetic field H₁ in the opposite direction of Hₐᵤₓ causing a reduction of the total magnetic flux density B in core 11.

In the absence of current I, core 11 is saturated by flux B; for example, B₁ is above B ₛₐₜ. When a current I starts to flow in coil 12, it partially compensates in at least one of the cores 11, the magnetic field Hₐᵤₓ of the auxiliary current Iₐᵤₓ. When the resulting magnetic flux density B₁ in the iron core 11 remains higher than the saturation flux density Bₛₐₜ, the inductance experienced by first coil 12 is low. However, when current I increases during a fault situation, H₁ will increase as well and will start to lower the resulting total magnetic flux density B₁ below Bₛₐₜ. Thus, core 11 becomes unsaturated. The permeability of the unsaturated core 11 is increased, and therefore also the inductance of current rise limiter 2 increases.

The exemplary current rise limiter 2 of FIG. 3 can be a saturated iron core type fault limiter with two cores 11. Those skilled in the art will appreciate, that if it can be assumed that current I flows in one direction only, a limiter with a single core and suitably oriented first and second coils 12, 13 can be used.

Another exemplary embodiment of current rise limiter 2 is shown in FIG. 4. This is basically a device architecture known for AC applications, and described for example in EP 2 091 054. It includes a ferromagnetic core 11 with a coil 12 wound around it. Coil 12 is in series to switching array 1.

In the embodiment of FIG. 4, core 11 is for example chosen to be annular. It has a magnetic polarization arranged non-parallel to the flux generated by the current I through coil 12. When current I is low, the polarization remains constant and the inductance remains low. When current I rises, the magnetic field generated by the current starts to affect the polarization, and inductance increases. We refer to EP 2 091 054 for the principles of operation of such a device, and the entire disclosure of the EP document is incorporated herein in its entirety by reference.

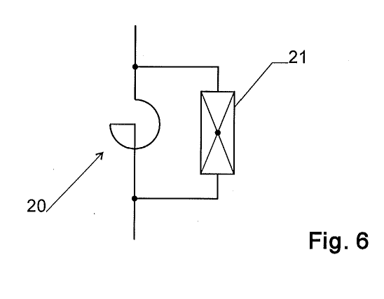

Another exemplary embodiment of current rise limiter 2 is a shielded iron core limiter as shown in FIG. 5. It includes an iron core 11 with a coil 12 carrying the current I wound around it. Coil 12 is again in series to switching array 1.

A superconducting shield 17, including (e.g., consisting of) a coil of superconducting material, is arranged between coil 12 and core 11, thereby shielding coil 12 magnetically from core 11 while the current I is low. As soon as the current I is high enough to induce a current of sufficient amplitude in shield 17, shield 17 looses its superconductive properties, the field of coil 12 penetrates into core 11, and the effective permeability of core 11 increases the inductance of coil 12. The resistivity of the no longer superconducting coil 17 acts like a resistance in the primary coil 12.

Another exemplary embodiment of a current rise limiter 2 is shown in FIG. 6. It can include an inductance 20 (and resistance) in parallel to an Is-limiter 21. Is-limiters, which have been known for AC applications only, are devices which include a current sensor as well as a combination of an extremely fast-acting switch, which can conduct a high rated current but has a low switching capacity, and a fuse with a high breaking capacity mounted in parallel to the switch.

When the current sensor detects a rise of the current, a small charge is used as a stored energy mechanism to interrupt the switch (main conductor). When the main conductor has been opened, the current flows through the parallel fuse, where it is limited to, for example, within less than one millisecond and is then shut down. The current then flows through the parallel inductance 20, which has an impedance value that is higher than that of the closed Is-limiter 21.

Several Is-limiters can be arranged in series if a single Is-limiter is unable to carry the full voltage over inductance 20.

The current sensor of the Is-limiter can be designed to be triggered, if current I exceeds a given threshold. Alternatively, or in addition thereto, it can be triggered if the time-derivative dI/dt exceeds a given threshold or a combination of both thresholds.

Notes:

Those skilled in the art will appreciate that FIG. 1 shows only one exemplary embodiment of switching assembly 1. Other types of switching assemblies can be used as well, as will be appreciated by those skilled in the art.

Some possible embodiments of current rise limiter 2 are described herein. However those skilled in the art will appreciate that any other type of current rise limiter can be used, if for example its inductance increases with I or dI/dt. For example, any inductive AC fault current limiter technology with an inductance increasing with the AC current can be used as a DC current rise limiter in accordance with the present disclosure.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE NUMERALS

1: switching assembly

2: current rise limiter

3: voltage source

4: load

5: fault

6: switch

7: arc gap

8: capacitor

9: inductance

10: arrester (varistor)

10b: switch

11: iron core

12, 13: first and second coils

14: current source

17: superconducting shield

20: inductance

21: Is-limiter

1. A method for limiting a current rise in a high voltage DC network, the method comprising:
selecting a current rise limiter which has an inductance that increases with a time-derivative dI/dt of a current I; and
arranging the inductive current rise limiter in the network.

2. The method of claim 1, wherein said current rise limiter has an inductance that increases with said current I.

3. The method of claim 2, wherein said selecting comprises:
choosing a current rise limiter which has an iron core with a first coil and with a second coil wound around the iron core, wherein said current I flows through said first coil, wherein an auxiliary current (Iaux) flows through said second coil, and wherein said current I generates a magnetic field in said core opposite to a magnetic field generated by said auxiliary current (Iaux).

4. The method of claim 2, wherein said selecting comprises:
choosing a current limiter having a ferromagnetic core with a polarization aligned non-parallel to a flux generated by said current I.

5. The method of claim 1, wherein said selecting comprises:
choosing a current rise limiter having a coil wound around a core with a superconducting shield arranged between said coil and said core.

6. The method of claim 1, wherein said selecting comprises:
choosing a current rise limiter having an inductance and an Is-limiter connected in parallel to the inductance.

7. A high-voltage DC circuit breaker, comprising:
a switching assembly for interrupting a high-voltage DC current I; and
an inductive current rise limiter arranged in series to said switching assembly, wherein said current rise limiter has an inductance that will increase with a time-derivative dI/dt of said current I.

8. The high-voltage DC circuit breaker of claim 7, wherein said current rise limiter has an inductance that will increase with said current I.

9. The high-voltage DC circuit breaker of claim 8, wherein said current rise limiter comprises:
an iron core with a first coil and a second coil wound around the core, wherein said first coil is in series to said switching assembly; and
a DC current source for generating an auxiliary DC current (Iaux) through said second coil, wherein a magnetic field when caused by said current I in said core will be opposite to a magnetic field when generated by said auxiliary current.

10. The high-voltage DC circuit breaker of claim 8, wherein said current limiter comprises:
a ferromagnetic core with a polarization which will be aligned non-parallel to a flux when generated by said current I.

11. The high-voltage DC circuit breaker of claim 7, wherein said current rise limiter comprises:
a coil wound around a core; and
a superconducting shield arranged between said coil and said core.

12. The high-voltage DC circuit breaker of claim 7, wherein the current rise limiter comprises:
an inductance; and
an Is-limiter connected in parallel to the inductance.

13. The high-voltage DC circuit breaker of claim 7, wherein said switching assembly comprises:
a mechanical switch with an arc gap, wherein said arc gap is arranged in a resonant circuit which includes a capacitor and a further inductance.

14. The high-voltage DC circuit breaker of claim 7, in combination with a high voltage DC network for breaking a high-voltage DC current, comprising:
a high voltage DC supply connected with the high-voltage DC circuit breaker.

15. A high-voltage DC network, comprising:
a high-voltage DC current supply; and
the high-voltage DC circuit breaker of claim 7 for breaking the high-voltage DC current.

16. The high-voltage DC circuit breaker of claim 8, wherein said current rise limiter comprises:
a coil wound around a core; and
a superconducting shield arranged between said coil and said core.

17. The high-voltage DC circuit breaker of claim 16, wherein the current rise limiter comprises:
an inductance; and
an Is-limiter connected in parallel to the inductance.

18. The high-voltage DC circuit breaker of claim 17, wherein said switching assembly comprises:
a mechanical switch with an arc gap, wherein said arc gap is arranged in a resonant circuit which includes a capacitor and a further inductance.
